(19) United States
(12) Patent Application Publication
(10) Pub. No.: US 2008/0007807 A1
(43) Pub. Date: Jan. 10, 2008

(54) Image processor and image processing method

(75) Inventors: Atsushi Yamada, Kawasaki (JP); Jun Uchita, Kawasaki (JP)

Correspondence Address: ARENT FOX LLP, 1050 CONNECTICUT AVENUE, N.W., SUITE 400, WASHINGTON, DC, 20036, US

(73) Assignee: FUJITSU LIMITED

(21) Appl. No.: 11/546,286

(22) Filed: Oct. 12, 2006

(30) Foreign Application Priority Data
Jun. 29, 2006 (JP) 2006-179682

(51) Int. Cl. H04N 1/46

(52) U.S. Cl. 358/540; 358/537

(57) ABSTRACT

A line memory has a source image area and a decoration image area allocated thereto. The source image area sequentially retains partial source image data corresponding to at least one line of a screenful of a source image. The decoration image area retains decoration image data corresponding to a decoration image for decoration of the source image. An image superimposing circuit repeatedly performs superimposing processing to superimpose the partial source image data retained in the line memory with partial decoration image data corresponding to the partial source image data, until a screenful of the source image is superimposed. Thus, the source image data and the decoration image data can be superimposed without use of a system bus. This can prevent increase in system bus utilization.

### CROSS REFERENCE TO RELATED APPLICATION

This application is based upon and claims the benefit of priority from Japanese Patent Application No. 2006-179682, filed on Jun. 29, 2006, the entire contents of which are incorporated herein by reference.

### BACKGROUND OF THE INVENTION

1. Field of the Invention

The present invention relates to an image processor and an image processing method for superimposing an input image from a camera or the like with a decoration image for decoration of the inputted image.

2. Description of the Related Art

Generally, such an image processor stores an input source image from a camera or the like in a system memory. A decoration image for decoration of the source image is stored in the system memory in advance. Then, the source image retained in the system memory is overwritten with the decoration image to thereby superimpose the source image with the decoration image. A superimposing image is read from the system memory, for example, by a display controller for display. The system memory is connected via a system bus to plural modules including a CPU controlling the system, a display controller, and so forth.

Further, there is another image processor which has a line memory with a capacity to accommodate image data of at least one line of a superimposing image made by superimposing plural images. The superimposing image retained in the line memory is then read sequentially line by line, for example, by a display controller for display (for example, refer to Japanese Unexamined Patent Application Publication No 2005-331674).

The image processor of this kind reads the decoration image retained in the system memory when superimposing the source image with the decoration image, so that the number of accesses to the system memory increases. For example, the image processor of this kind stores the source image in the system memory before superimposing an image. Then, the image processor reads from the system memory the decoration image which is retained in the system memory in advance, and overwrites the source image in the system memory with the read decoration image, thereby superimposing an image. Thus, for superimposing the decoration image with the source image, the system memory needs to be accessed three times. As the number of accesses to the system memory needed for image superimposing processing increases, the system bus utilization increases. While the system bus is used for the image superimposing processing, other modules such as a CPU cannot use the system bus. This degrades system performance.

Further, there is another image processor which outputs a superimposing image from the line memory. For superimposing an image, it stores a source image in the system memory in advance. Then, the image processor reads from the system memory decoration image data and source image data corresponding to the number of lines of the line memory. Superimposing read image data is then continued until a superimposing image of a size of one screen is obtained. Therefore, for superimposing the decoration image with the source image, the system memory needs to be accessed at least three times. As the number of accesses to the system memory needed for image superimposing processing increases, the system bus utilization increases. While the system bus is used for the image superimposing processing, other modules such as a CPU cannot use the system bus. This degrades system performance.

### SUMMARY OF THE INVENTION

An object of the present invention is to reduce, with use of a line memory of a small memory capacity, the number of accesses to a system memory needed for superimposing an image, and prevent increase in system bus utilization, and to decrease a system memory area needed for image superimposing processing.

According to an aspect of the present invention, the line memory has a source image area and a decoration image area allocated thereto. The source image area sequentially retains partial source image data corresponding to at least one line of a screenful of a source image. The decoration image area retains decoration image data corresponding to a decoration image for decoration of a source image.

An image superimposing circuit repeatedly performs superimposing processing to superimpose the partial source image data retained in the line memory with partial decoration image data corresponding to the partial source image data, until the source image is superimposed. Specifically, the image superimposing circuit superimposes source image data with decoration image data which are retained in the line memory. Thus, the source image data and the decoration image data can be superimposed without use of a system bus. This can prevent an increase in system bus utilization, moreover, reduce the system memory area needed for the image superimposing processing.

### BRIEF DESCRIPTION OF THE DRAWINGS

The nature, principle, and utility of the invention will become more apparent from the following detailed description when read in conjunction with the accompanying drawings in which like parts are designated by identical reference numbers, in which:

FIG. 1 is a block diagram showing a first embodiment of the present invention;

FIG. 2 is an explanatory view of operation of the first embodiment;

FIG. 3 is a block diagram showing a second embodiment of the present invention;

FIG. 4 is a block diagram showing a third embodiment of the present invention;

FIG. 5A and FIG. 5B are explanatory views of operation of the third embodiment;

FIG. 6 is a block diagram showing a comparative example of the present invention;

FIG. 7 is a block diagram showing a fourth embodiment of the present invention;

FIG. 8 is an explanatory view of operation of the fourth embodiment;

FIG. 9 is a block diagram showing a fifth embodiment of the present invention;

FIG. 10 is an explanatory view of operation of the fifth embodiment;

FIG. 11 is a block diagram showing a sixth embodiment of the present invention;

FIG. 12 is an explanatory view of operation of writing and reading decoration image data of the sixth embodiment;

FIG. 13 is a block diagram showing a seventh embodiment of the present invention;

FIG. 14 is an explanatory view of operation of the seventh embodiment;

FIG. 15A and FIG. 15B are explanatory views of a concrete example of operation of the seventh embodiment;

FIG. 16 is a block diagram showing an eighth embodiment of the present invention;

FIG. 17 is an explanatory view of operation of the eighth embodiment;

FIG. 18 is a block diagram showing a ninth embodiment of the present invention;

FIG. 19 is a block diagram showing a tenth embodiment of the present invention;

FIG. 20 is a block diagram showing an eleventh embodiment of the present invention; and

FIG. 21 is a block diagram showing a twelfth embodiment of the present invention.

### DESCRIPTION OF THE PREFERRED EMBODIMENTS

Hereinafter, embodiments of the present invention will be described with reference to the drawings.

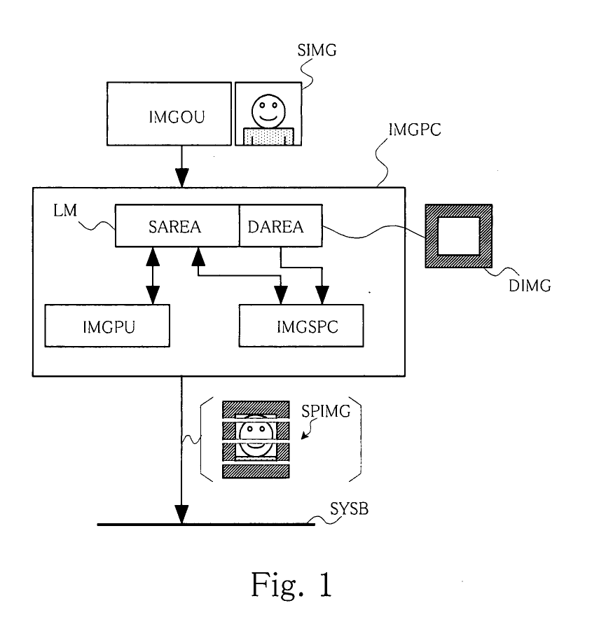

FIG. 1 shows a first embodiment of the present invention. This embodiment shows basic principles of the present invention. The image processor has an image processing circuit IMGPC. The image processing circuit IMGPC has a line memory LM, an image processing part IMGPU and an image superimposing circuit IMGSPC. The image processor is mounted in a digital camera for example. In a digital camera in which the image processor is mounted, an image output unit IMGOU supplying image data to the image processing circuit IMGPC corresponds to, for example, a unit having an image sensor of the camera and an AD converter.

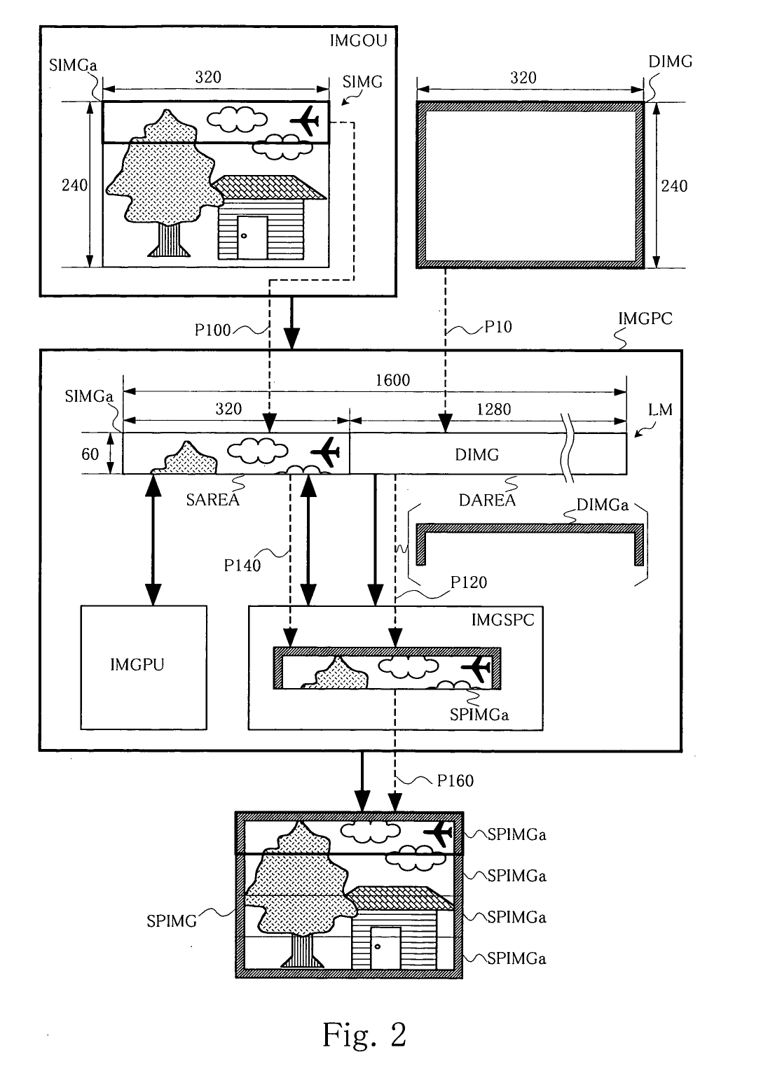

The line memory LM is connected to the image processing part IMGPU and the image superimposing circuit IMGSPC. The line memory LM has a source image area SAREA and a decoration image area DAREA allocated thereto. The source image area SAREA receives partial source image data corresponding to a partial source image of 60 lines of a source image SIMG sequentially from the image output unit IMGOU for example, and retains the received data sequentially. Here, the source image SIMG is a screenful of an image captured by a camera. The source image data are image data for composing the source image. The partial source image is an image generated from the partial source image data retained in the line memory LM out of the source image. Sizes of the source image area SAREA and the decoration image area DAREA will be described in detail with reference to FIG. 2.

The decoration image area DAREA retains decoration image data corresponding to a decoration image DIMG for decoration of the source image SIMG. The decoration image DIMG is, for example, an image of a picture frame. For example, the image superimposing circuit IMGSPC superimposes only an oblique line portion on the periphery of the decoration image DIMG with the source image SIMG. Hereinafter, an image and image data of the image are denoted by the same reference symbol. For example, a reference symbol SIMG in a diagram denotes a source image and source image data, and a reference symbol DIMG denotes a decoration image and decoration image data.

The image processing part IMGPU reads the partial source image data sequentially from the line memory LM, and performs general image processing such as enlarging/reducing of the source image SIMG and filtering. The partial source image data which are image processed are written back to the source image area SAREA of the line memory LM.

The image superimposing circuit IMGSPC repeatedly performs superimposing processing to partially superimpose the partial source image data retained in the line memory LM with partial decoration image data corresponding to the partial source image data out of the decoration image data DIMG until a superimposed source image SPIMG is generatable. Partial superimposing image data obtained by the above operation are outputted to the system bus SYSB sequentially. The image processor of this embodiment does not need to use the system bus for superimposing the source image data with the decoration image data. As a result, it is preventable of an increase in system bus utilization.

FIG. 2 shows an example of operation of the first embodiment. Dashed lines in the drawing show the flow of image processing. The line memory LM has a storage capacity of retaining 60 lines of image data of 1600 pixels for example. In this embodiment, the size of the source image SIMG is 320 pixels×240 pixels (QVGA size). The source image area SAREA of the line memory LM is assigned a capacity of retaining partial source image data SIMGa corresponding to a partial source image SlMGa of 60 lines (320 pixels×60 lines) of the source image SIMG. The remaining area (1280 pixels×60 lines) of the line memory LM is used for the decoration image area DAREA. Accordingly, the decoration image area DAREA can retain decoration image data DIMG of 76800 pixels. Therefore, the decoration image area DAREA can retain decoration image data DIMG of 320 pixels×240 pixels (76800 pixels) corresponding to one image. The image processor of this embodiment operates as follows.

First, in process P10, the decoration image data DIMG are stored in advance in the decoration image area DAREA of the line memory LM before image superimposing processing.

In process P100, the source image area SAREA retains sequentially the partial source image data SIMGa corresponding to 60 lines of the source image SIMG supplied sequentially from the image output unit IMGOU. In process P120, the image superimposing circuit IMGSPC reads the partial decoration image data DIMGa from the decoration image area DAREA. Coordinates of the partial decoration image data DIMGa are the same as those of the partial source image data SIMGa retained in the source image area SAREA. In process P140, the image superimposing circuit IMGSPC reads the partial source image data SIMGa retained in the source image area SAREA. In synchronization with the reading, next partial source image data SIMGa are written to the line memory LM.

The image superimposing circuit IMGSPC superimposes the read partial decoration image data DIMGa with the read partial source image data SIMGa. Thus, a partial superimposing image SPIMGa corresponding to 60 lines of the source image SIMG is generated. This superimposing processing is performed only on, for example, pixels, of the decoration image data DIMG, having colors different from a predetermined pixel color. For example, if pixel data having the predetermined color are “0”, the image superimposing circuit IMGSPC superimposes pixel data other than “0” out of pixel data of the decoration image data DIMG with the source image data SIMG. In this embodiment, image data corresponding to a void portion on the center of the decoration image DIMG are set to “0”. Therefore, the oblique line portion on the periphery of the decoration image DIMG is superimposed with the partial source image SIMGa, and the void portion on the center thereof is not superimposed with the partial source image SIMGa.

In process P160, the image superimposing circuit IMGSPC outputs the partial superimposing image data SPIMGa to the system bus SYSB shown in FIG. 1. In this embodiment, the image processing circuit IMGPC repeats the above-described processes P100 to P160 four times and outputs four partial superimposing image data SPIMGa sequentially. Final superimposing image data SPIMG are obtained when fourth partial superimposing image data SPIMGa are outputted.

As above, in the first embodiment, the decoration image data DIMG are retained in the line memory LM, so that the image data can be superimposed while receiving the partial source image data SIMGa. Therefore, in this embodiment, reception of the partial source image data SIMGa, superimposition of the partial source image data SIMGa with the partial decoration image data DIMGa and output of the partial superimposing image data SPIMGa can be processed in parallel. It is not needed to write back the partial superimposing image data SPIMGa to the line memory LM. Accordingly, a time from reception of the source image data SIMG to completion of superimposition of the source image data SIMG with the decoration image data DIMG can be shortened. Further, since the partial source image data SIMGa and the partial decoration image data DIMGa are retained in the line memory LM, it is not necessary to use the system bus SYSB shown in FIG. 1 for superimposing processing. As a result, increase in system bus utilization SYSB can be prevented.

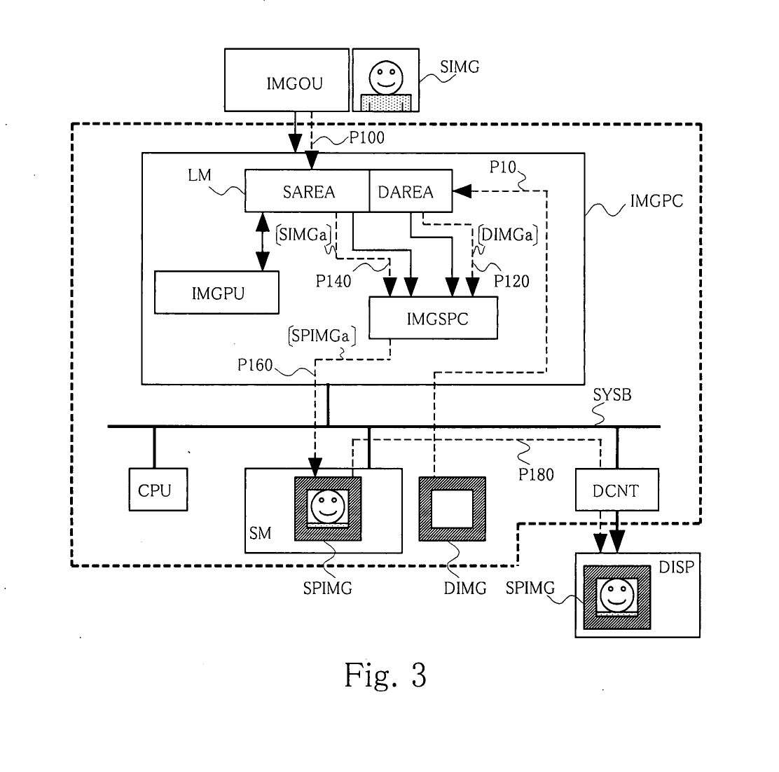

FIG. 3 shows a second embodiment of the present invention. The same elements as those explained in the first embodiment are designated the same reference symbols, and detailed descriptions of which are omitted. An image processor in this embodiment is constituted by adding a CPU, a system memory SM and a display controller DCNT to the first embodiment. The image processor is mounted in a digital camera for example. The image processing circuit IMGPC, the CPU and the display controller DCNT are connected to the system memory SM via the system bus SYSB. The display controller DCNT is connected to a display DISP. The display DISP is a liquid crystal display for example. The CPU is a central processing unit controlling the entire image processor. The system memory SM is a main memory and stores superimposing image data SPIMG superimposed by the image processing circuit IMGPC, a program executed by the CPU, and so forth.

Operation of the image processing circuit IMGPC is the same as that of the image processing circuit IMGPC of the first embodiment, and thus the description of the processes P10-P140 is omitted. In process P160, the image superimposing circuit IMGSPC outputs partial superimposing image data SPIMGa generated in the processes P10-P140 to the system memory SM sequentially. Thus, a screenful of superimposing image data SPIMG are stored in the system memory SM. In the image processor of this embodiment, access to the system memory SM at the time of superimposing an image only occurs when outputting the partial superimposing image data SPIMGa.

In process P180, the display controller DCNT reads the superimposing image data SPIMG from the system memory SM, and displays the superimposing image SPIMG on the display DISP. As above, also in the second embodiment, the same effect as the above-described first embodiment is obtainable.

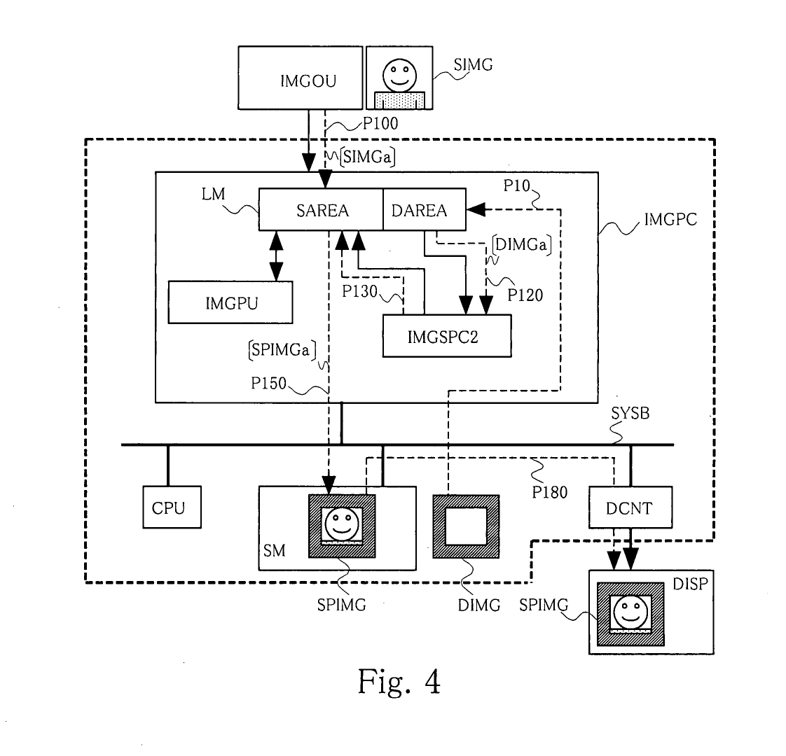

FIG. 4 shows a third embodiment of the present invention. The same elements as those explained in the second embodiment are designated the same reference symbols, and detailed descriptions of which are omitted. In an image processor of this embodiment, an image superimposing circuit IMGSPC2 is formed instead of the image superimposing circuit IMGSPC of the second embodiment. The other structure is the same as the second embodiment. The image processor is mounted in a digital camera for example. Processes P10-P120 and a process P180 are the same as the above-described processes of FIG. 3.

The image superimposing circuit IMGSPC2 reads partial decoration image data DIMGa corresponding to partial source image data SIMGa out of the decoration image data DIMG retained in the decoration image area DAREA (process P120). The image superimposing circuit IMGSPC2 overwrites the read partial decoration image data DIMGa on the partial source image data SIMGa retained in the source image area SAREA (process P130). Then, by overwriting the partial decoration image data DIMGa on the partial source image data SIMGa, partial superimposing image data SPIMGa are generated.

The system memory SM reads the partial superimposing image data retained in the source image area SAREA of the line memory LM (process P150). In synchronization with this reading, next partial source image data SIMGa are written in the line memory LM. In the image processor of this embodiment, similarly to the second embodiment, access to the system memory SM at the time of superimposing an image only occurs when outputting the partial superimposing image data SPIMGa.

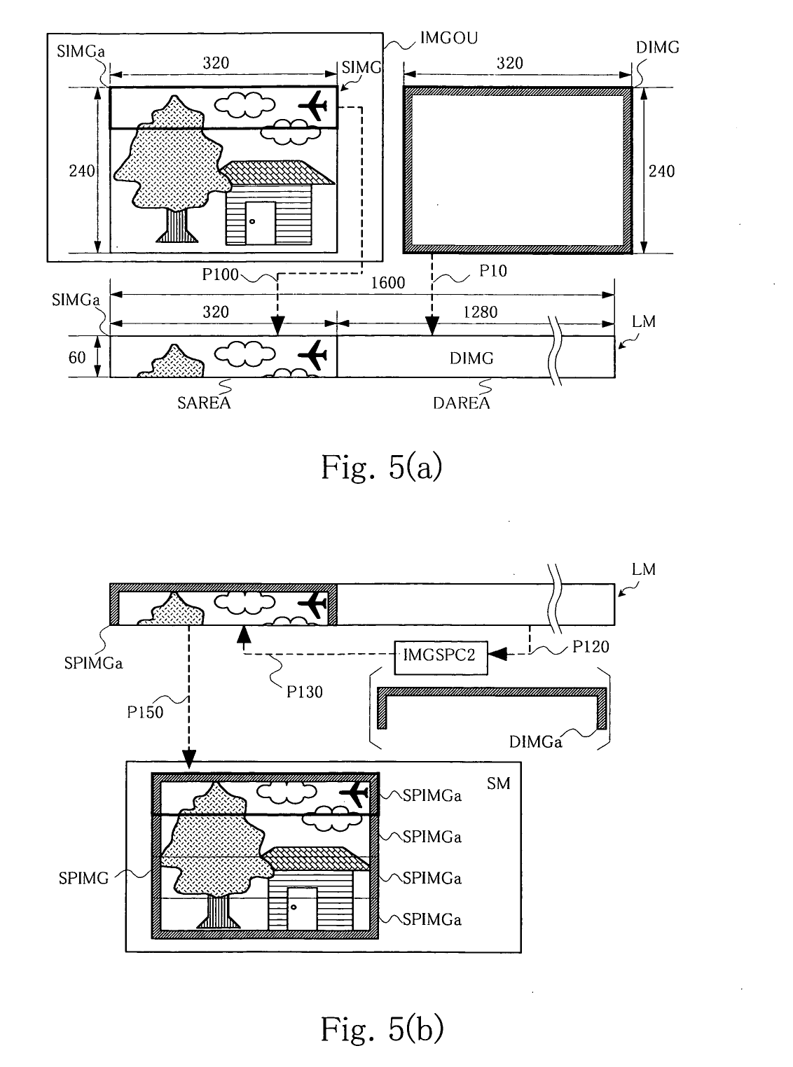

FIG. 5A and FIG. 5B show an example of operation of the third embodiment. FIG. 5A shows operation until storing of the partial source image data SIMGa in the line memory LM. FIG. 5B shows operation of superimposing the partial source image data SIMGa with the partial decoration image data DIMGa, which are retained in the line memory LM. The storage capacity of the line memory LM, area allocation of the line memory LM, the size of a source image SIMG and the size of a decoration image are the same as in the above-described first embodiment (FIG. 2).

Since processes P10, P100, P120 are the same as in the above-described first embodiment, detailed descriptions of which are omitted. In this embodiment, instead of the processes P140 and P160 of the first embodiment, processes P130 and P150 are performed respectively.

In FIG. 5B, in the process P130, the image superimposing circuit IMGSPC2 overwrites the partial source image data SIMGa retained in the source image area SAREA with the partial decoration image data DIMGa read in the process P120. By this overwriting, the partial source image data SIMGa are superimposed with the partial decoration image data DIMGa. The partial superimposing image SPIMGa corresponding to 60 lines of the source image SIMG is retained in the source image area SAREA of the line memory LM. The overwriting in the process P130 is performed only on, for example, pixels, of the partial decoration image data DIMGa, having colors different from a predetermined pixel color, similarly to the superimposing processing explained in the first embodiment. Specifically, the image superimposing circuit IMGSPC2 overwrites image data corresponding to the oblique line portion on the periphery of the partial decoration image DIMGa on the partial source image data SIMGa, but does not overwrite image data corresponding to the void portion on the center on the partial source image data SIMGa.

In the process P150, the partial superimposing image data SPIMGa generated in the processes P10-P130 are outputted sequentially from the line memory LM to the system memory SM. Thus, a screenful of superimposing image data SPIMG are stored in the system memory SM. In the image processor of this embodiment, access to the system memory SM at the time of superimposing an image only occurs when outputting the partial superimposing image data SPIMGa.

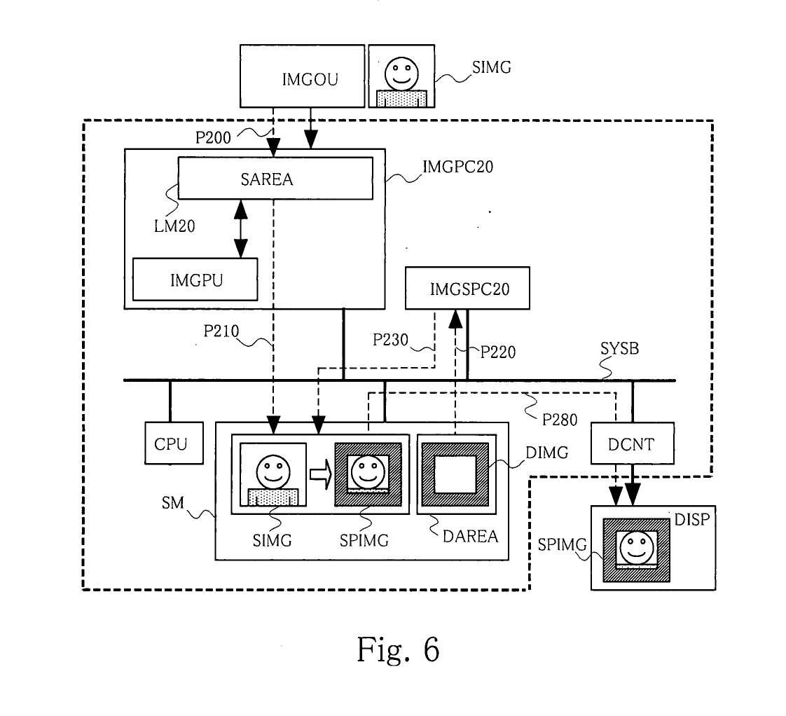

FIG. 6 shows a comparative example of the present invention. In an image processor shown in FIG. 6, an image superimposing circuit IMGSPC20 is formed instead of the image superimposing circuit IMGSPC2 of the third embodiment. The image superimposing circuit IMGSPC20 is connected to a system bus SYSB. An image processing circuit IMGPC20 has only the image processing part IMGPU and does not include the image superimposing circuit. Accordingly, the line memory LM20 has only the source image area SAREA, and has a storage capacity of retaining 60 lines of image data of 1600 pixels for example. A system memory SM has a decoration image area DAREA for retaining decoration image data DIMG. The image processor shown in FIG. 6 operates as follows.

First, in process P200, the source image area SAREA retains sequentially partial source image data SIMGa corresponding to 60 lines of a source image SIMG which are supplied sequentially from an image output unit IMGOU. In process P210, the system memory SM reads sequentially partial source image data from the line memory LM20 until a screenful of source image data SIMG are retained.

In process P220, the image superimposing circuit IMGSPC20 reads the decoration image data DIMG retained in the system memory SM. In process P230, the image superimposing circuit IMGSPC20 overwrites the read decoration image data DIMG on the source image data SIMG in the system memory SM. In the image processor of this example, it is necessary to transfer (processes P210, P220 and P230) of data corresponding to a screenful of the source image SIMG to the system memory SM three times so as to superimpose the decoration image DIMG with the source image SIMG. Therefore, a data transfer amount to the system memory SM increases by three times as compared to the image processor shown in FIG. 4. In other words, in the present invention, an system bus utilization SYSB for image superimposing processing can be suppressed to thereby prevent increase in system bus utilization SYSB of the entire system.

In process P280, the display controller DCNT reads superimposing image data SPIMG from the system memory SM to display the superimposing image SPIMG on the display DISP.

As above, also in the third embodiment, the same effect as the above-described second embodiment is obtainable. Furthermore, since the partial superimposing image data SPIMGa as output image data are retained in the line memory LM, the interface of the system bus SYSB of this embodiment may have the same structure as a conventional image processor to read the partial source image data SIMGa from the line memory LM. Therefore, according to this embodiment, it is possible to utilize design assets such as peripheral devices of the system bus SYSB, and shorten the development period for a system product as a digital camera or the like.

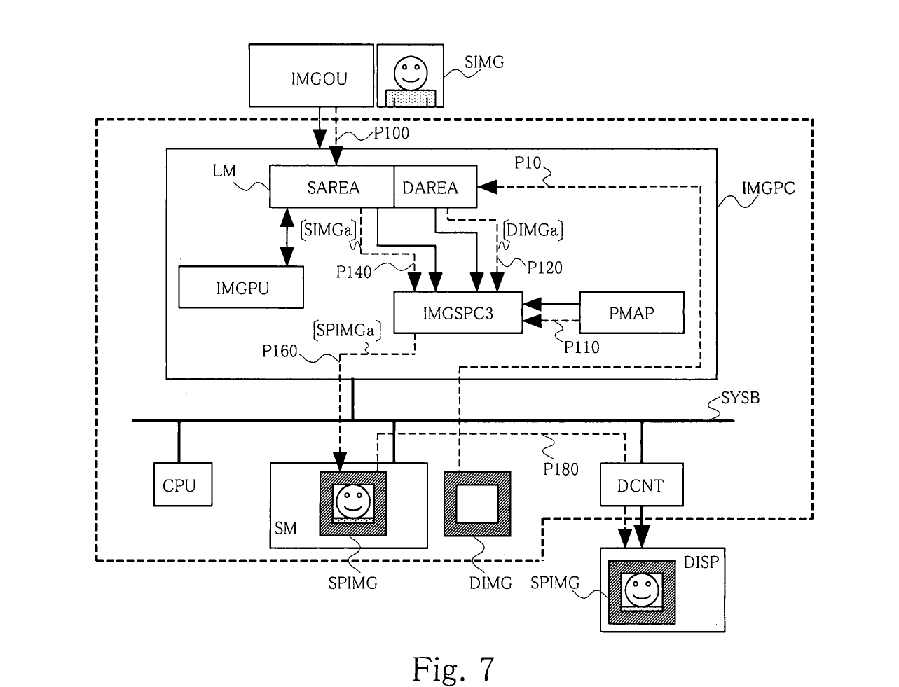

FIG. 7 shows a fourth embodiment of the present invention. The same elements as those explained in the second embodiment are designated the same reference symbols, and detailed descriptions of which are omitted. In an image processor of this embodiment, an image superimposing circuit IMGSPC3 is formed instead of the image superimposing circuit IMGSPC of the second embodiment. Further, the image processor is constituted by adding a pixel map PMAP to the second embodiment. The other structure is the same as the second embodiment. The image processor is mounted in a digital camera for example. In the image processor, in addition to the processes in the second embodiment, a process P110 is performed. Processes P10-P120, P160 and P180 are the same as in the above-described second embodiment, and thus detailed descriptions of which are omitted.

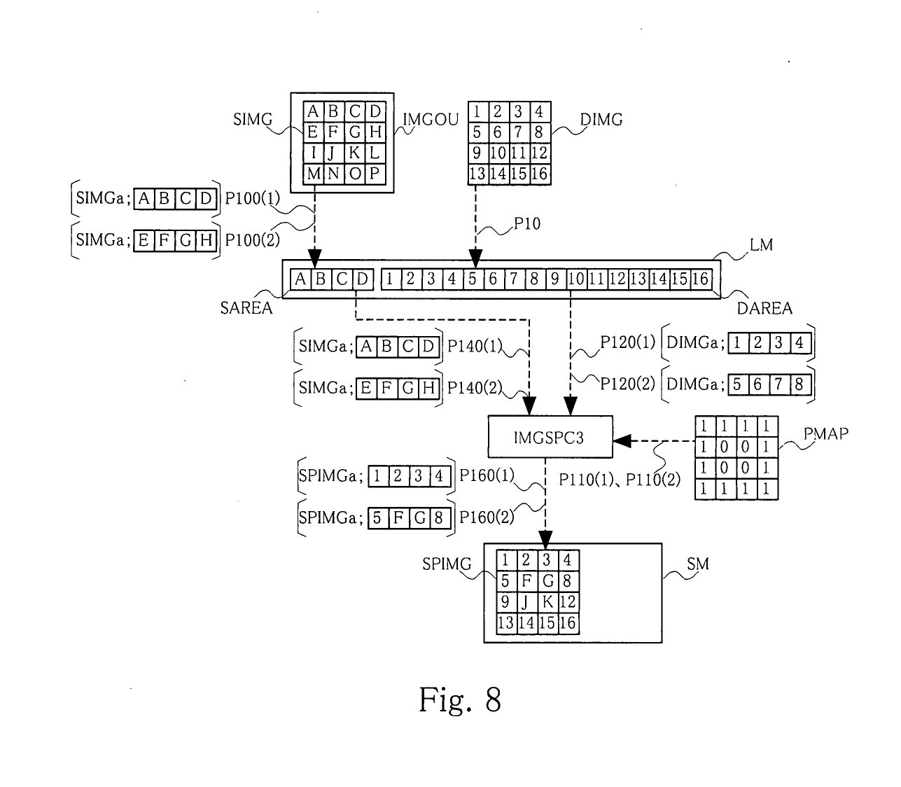

The pixel map PMAP is connected to the image superimposing circuit IMGSPC3. The pixel map PMAP is a memory storing superimposing information indicating whether or not each pixel of decoration image data DIMG is to be superimposed with source image data SIMG. For example, when the superimposing information stored in the image map PMAP is “1”, pixel data of corresponding partial decoration image data DIMGa are superimposed with the partial source image data SIMGa. Further, when the superimposing information stored in the pixel map PMAP is “0”, pixel data of corresponding partial decoration image data DIMGa are not superimposed with the partial source image data SIMGa. Details of the image map PMAP will be explained with FIG. 8 described below.

FIG. 8 shows one example of operation of the fourth embodiment. In image superimposing processing of FIG. 8, a process P110 (P110(1), P110(2); operation of using the pixel map PMAP) is added to the above-described operation of FIG. 3. The numbers in the parentheses of the process numbers are denoting the order of processes which are performed repeatedly. In this embodiment, for simplification of description, sizes of a source image SIMG and a decoration image DIMG are set to 4 pixels×4 pixels. In practice, the sizes of a source image SIMG and a decoration image DIMG are 320 pixels×240 pixels or the like as shown in the above-described FIG. 2. Source image data SIMG (“A-P”) correspond to respective pixels from the top left to the bottom right. Decoration image data DIMG (“1-16”) correspond to respective pixels from the top left to the bottom right. The pixel map PMAP stores “1” indicating “to superimpose” in positions corresponding to 12 pixels on the periphery of the decoration image DIMG, and stores “0” indicating “not to superimpose” in positions corresponding to four pixels on the center of the decoration image DIMG.

The storage capacity of the line memory LM is 20 pixels×1 line for example. The source image area SAREA of the line memory LM stores one line (four pixels) of the source image SIMG. Thus, the remaining area of the line memory LM can be used for the decoration image area DAREA capable of retaining image data of 4 pixels×4 lines. Therefore, all of the decoration image data DIMG can be retained in the decoration image area DAREA of the line memory LM.

Processes P10, P100, P120, P140 and P160 are the same as those in the second embodiment, and thus detailed descriptions of which are omitted.

In process 110(1), the image superimposing circuit IMGSPC3 reads superimposing information “1111” in the pixel map PMAP corresponding to the partial decoration image DIMGa for decoration of a partial source image SIMGa corresponding to one line of the source image SIMG. In the processes P120(1) and P140(1), the image superimposing circuit IMGSPC3 reads partial decoration image data DIMGa (“1234”) for decoration of a first line of the source image SIMG and the partial source image data SIMGa (“ABCD”) from the line memory LM. Since the superimposing information read in the process P110(1) is “1” indicating “to superimpose”, all the partial decoration image data DIMGa (“1234”) is to be the partial superimposing image data SPIMGa (“1234”). Therefore, in process P160(1), the image superimposing circuit IMGSPC3 outputs the partial decoration image data DIMGa (“1234”) read in the process P120(1) to the system memory SM.

Processing of a second line of the source image SIMG is performed similarly to the above-described processes P100(1) to P160(1). However, superimposing information in the pixel map PMAP corresponding to a second line of the decoration image DIMG is “1001”, so that operation in process 160(2) is different. In the process 160(2), the image superimposing circuit IMGSPC3 outputs partial decoration image data DIMGa at coordinates where superimposing information corresponds to “1” and outputs partial source image data SIMGa at coordinates where superimposing information corresponds to “0”. For example, when superimposing partial source image data SIMGa (“EFGH”) with partial decoration image data DIMGa (“5678”), the image superimposing circuit IMGSPC3 superimposes image data based on the superimposing information “1001” read in the process P110(2), and outputs superimposed partial superimposing image data SPIMGa (“5FG8”) to the system memory SM.

The image superimposing circuit IMGSPC3 performs the above-described processes P100 to P160 also for partial decoration image data DIMGa (“9-12” and “13-16”) and outputs partial superimposing image data SPIMGa (“9JK12” and “13-16”) sequentially to the system memory SM. Thus, a screenful of superimposing image data SPIMG are stored in the system memory SM.

As above, also in the fourth embodiment, the same effect as the above-described second embodiment is obtainable. Furthermore, the image processor of this embodiment superimposes the partial source image data SIMGa with the partial decoration image data DIMGa based on the superimposing information stored in the pixel map PMAP. Accordingly, by changing the superimposing information stored in the pixel map PMAP, the equivalent effect as using plural decoration image data DIMG can be obtained with one decoration image data DIMG. Therefore, in a system mounting this image processor, when plural decoration images DIMG are needed, it is possible to decrease the storage capacity of a memory for storing the decoration image data DIMG, for example the system memory SM. Further, when plural decoration images DIMG are needed, access to the system memory SM can be suppressed since one decoration image data DIMG is needed to be stored in the line memory LM. As a result, when plural decoration images DIMG are needed, it is possible to prevent increase in system bus utilization.

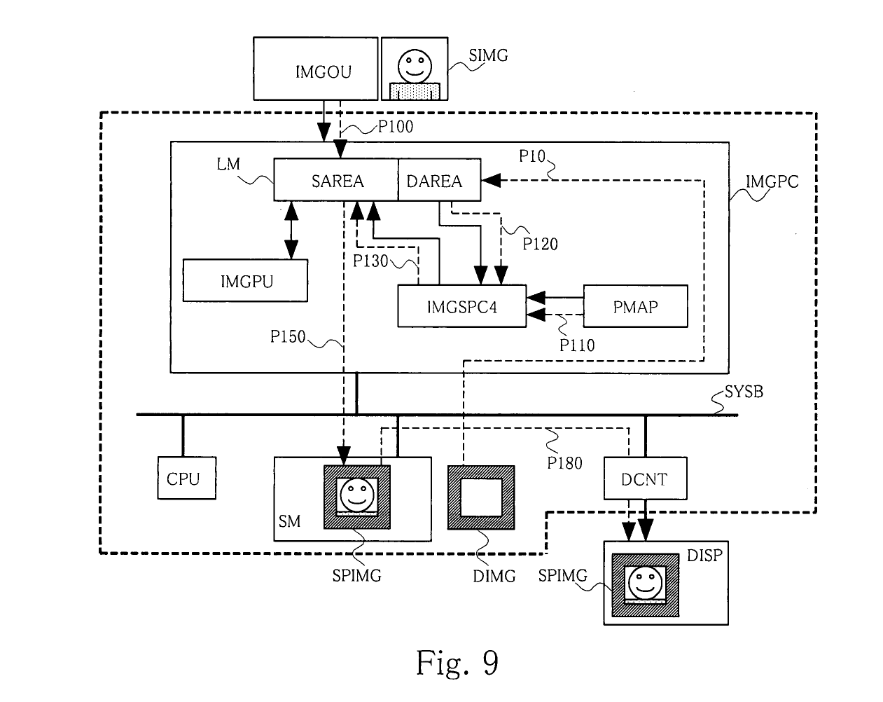

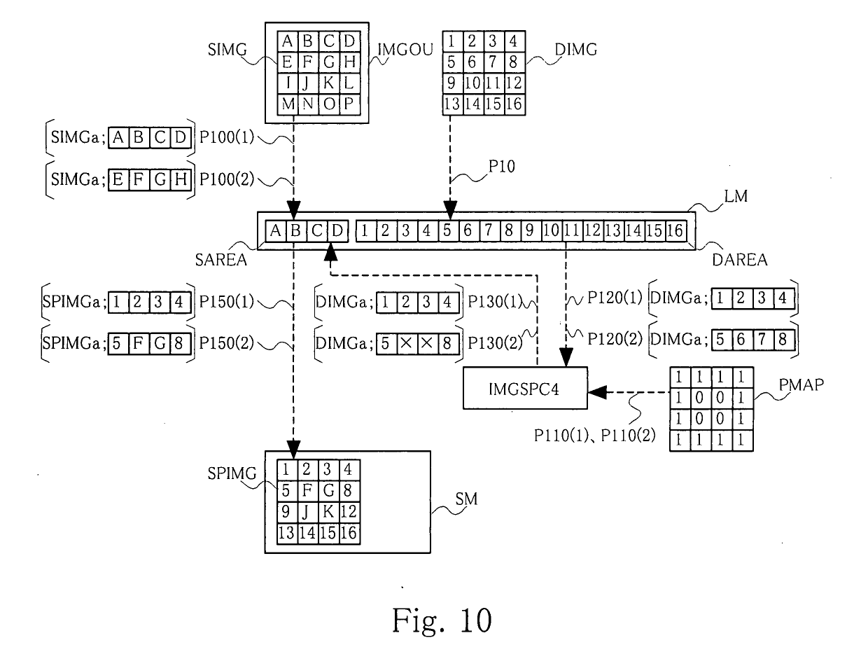

FIG. 9 shows fifth embodiment of the present invention. The same elements as those explained in the fourth embodiment are designated the same reference symbols, and detailed descriptions of which are omitted. In an image processor of this embodiment, an image superimposing circuit IMGSPC4 is formed instead of the image superimposing circuit IMGSPC3 of the fourth embodiment. The other structure is the same as the fourth embodiment. The image processor is mounted in a digital camera for example. Processes P10-P120 and process P180 are the same as the processes in the above-described fourth embodiment, and thus detailed descriptions of which are omitted. Only a process P130 different from the fourth embodiment will be described using FIG. 10. A process P150 is the same as the process in the third embodiment.

FIG. 10 shows one example of operation of the fifth embodiment. Processes P10, P100, P110, P120 are the same as in the above-described fourth embodiment, and thus detailed descriptions of which are omitted. In this embodiment, instead of the processes P140 and P160 of the fourth embodiment, processes P130 and P150 are performed. The storage capacity of the line memory LM, area allocation of the line memory LM, the size of a source image SIMG and the size of a decoration image DIMG are the same as in the above-described fourth embodiment (FIG. 8).

In process P130(1), according to a first line (“1111”) of the pixel map PMAP, the image superimposing circuit IMGSPC4 overwrites partial decoration image data DIMGa (“1234”) on partial source image data SIMGa (“ABCD”) in the line memory LM. By overwriting in the process P130(1), the partial source image data SIMGa are superimposed with the partial decoration image data DIMGa. In the process 150(1), partial superimposing image data SPIMGa (“1234”) are outputted from the line memory LM to the system memory SM.

Processing of a second line and thereafter of the source image SIMG is performed according to the pixel map PMAP similarly to the above-described processes P100(1)-P150(1). The symbol “x” shown on the left side of a process 130(2) shows that pixel data of the partial decoration image data DIMGa are not overwritten on the partial source image data SIMGa.

The image superimposing circuit IMGSPC4 performs the above-described processes P100-P150 for partial decoration image data DIMGa (“5-8”, “9-12” and “13-16”). Then, the partial superimposing image data SPIMGa (“5FG8”, “9JK12” and “13-16”) are outputted sequentially from the source image area of the line memory LM to the system memory SM. Thus, a screenful of superimposing image data SPIMG are stored in the system memory SM.

As above, also in the fifth embodiment, the same effect as the above-described third and fourth embodiments can be obtained.

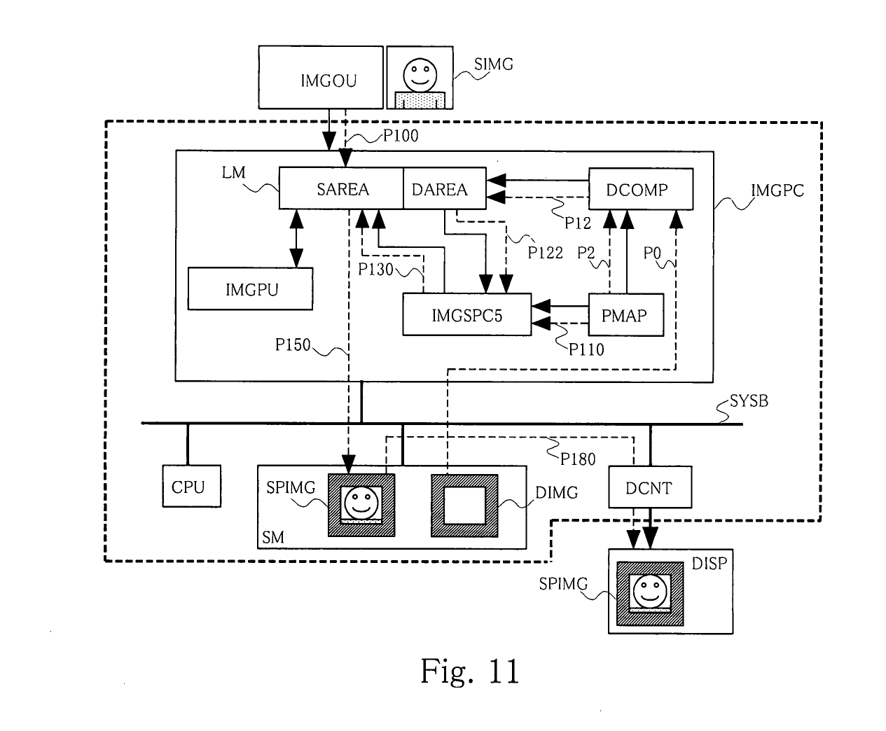

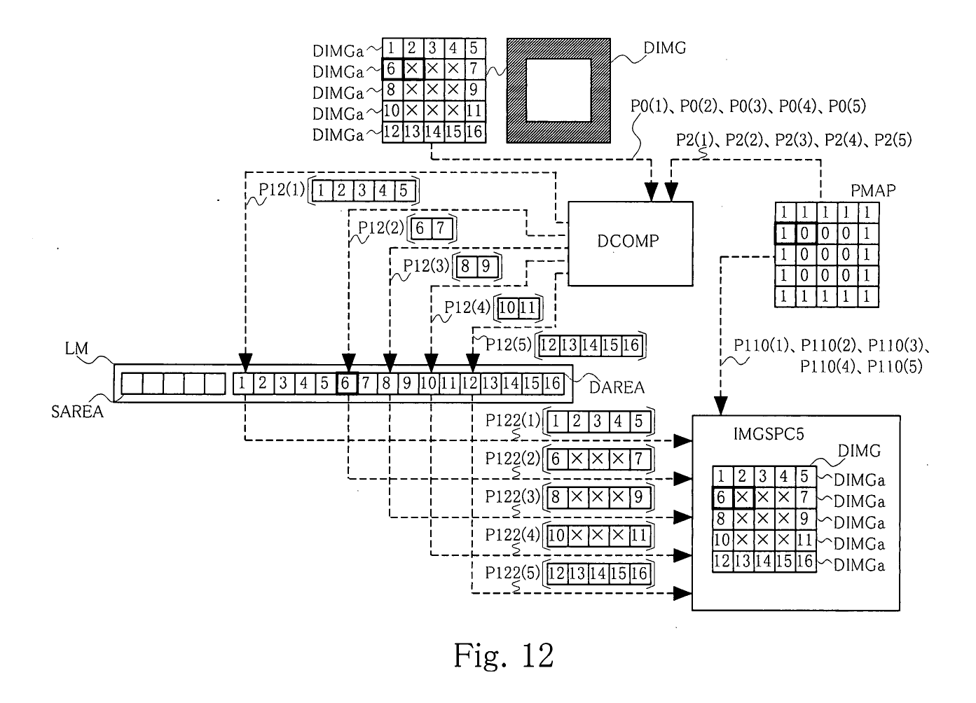

FIG. 11 shows a sixth embodiment of the present invention. The same elements as those explained in the fifth embodiment are designated the same reference symbols, and detailed descriptions of which are omitted. In an image processor of this embodiment, an image superimposing circuit IMGSPC5 is formed instead of the image superimposing circuit IMGSPC4 of the fifth embodiment. Further, the image processor is constituted by adding a decoration image compression unit DCOMP to the fifth embodiment. The other structure is the same as in the fifth embodiment. The image processor is mounted in a digital camera for example. Processes P100, P110, P130-P180 are the same as the processes in the above-described fifth embodiment, and thus detailed descriptions of which are omitted. Processes P0, P2, P12 and P122 different from the fifth embodiment will be explained using FIG. 12 described later.

The decoration image compression unit DCOMP is connected to the line memory LM and the pixel map PMAP. The decoration image compression unit DCOMP only writes decoration image data corresponding to “pixels to superimpose” indicated by the superimposing information stored in the pixel map PMAP in the line memory LM, so as to decrease a data amount of decoration image data DIMG written in a decoration image area DAREA. Thus, the decoration image area DAREA of the line memory LM can be reduced.

FIG. 12 shows an example of writing and reading decoration image data DIMG in the sixth embodiment. A process P110 is the same as the process in the above-described fifth embodiment, and thus a detailed description of which is omitted. In this embodiment, for simplicity of explanation, the size of the decoration image DIMG is set to 5 pixels×5 pixels. Decoration image data DIMG (“1-16”) correspond to 16 pixels on the periphery. Image data “x” corresponding to 9 pixels on the center of the decoration image DIMG are data not to be superimposed. The pixel map PMAP stores “1” indicating “to superimpose” in places corresponding to the 16 pixels on the periphery of the decoration image DIMG, and stores “0” indicating “not to superimpose” in positions corresponding to the 9 pixels on the center of the decoration image DIMG.

The storage capacity of the line memory LM is, for example, 21 pixels×1 line. The source image area SAREA of the line memory LM stores, for example, one line (5 pixels) of the source image SIMG. Accordingly, the remaining area of the line memory LM can be used for the decoration image area DAREA of a capacity to retain image data of 16 pixels×1 line. Therefore, image data of 16 pixels can be retained in the decoration image area DAREA of the line memory LM.

First, when writing the decoration image data DIMG in the line memory LM, in the process P0(1), the decoration image compression unit DCOMP reads partial decoration image data DIMGa (“12345”) of a first line of the decoration image DIMG. In the process P2(1), the decoration image compression unit DCOMP reads superimposing information (“11111”) of a first line of the pixel map PMAP corresponding to the read partial decoration image data DIMGa (12345). In the process P12(1), since the read superimposing information is “11111”, the decoration image compression unit DCOMP writes all the partial decoration image data DIMGa (“12345”) in the decoration image area DAREA of the line memory LM.

Processing of a second line of the decoration image DIMG is performed similarly to the above-described processes P0(1), P(2) and P(12). However, superimposing information in the pixel map PMAP corresponding to a second line of the decoration image DIMG is “10001”, so that operation in the process P12(2) is different. In the process P12(2), the decoration image compression unit DCOMP writes partial decoration image data DIMGa at coordinates where superimposing information corresponds to “1” in the decoration image area DAREA. For example, when writing partial decoration image data DIMGa (“6xxx7”) in the decoration image area DAREA, the decoration image compressing unit DCOMP writes in the decoration image area DAREA only image data “6”, “7” for which the superimposing information read in the process P2(2) indicate “1”. The decoration image compression unit DCOMP performs the above-described processes P0-P12 for remaining three lines of the partial decoration image data DIMGa. Accordingly, image data of third, fourth and fifth lines to be written in the decoration image area DAREA are “8, 9”, “10, 11”, and “12-16”. Therefore, in the decoration image area DAREA, only image data corresponding to 16 pixels to be superimposed with the partial source image data SIMGa out of 25 pixels of the decoration image DIMG are stored. Accordingly, the storage capacity of the decoration image area DAREA of the line memory LM can be reduced. The above-described processes P0, P2 and P12 are executed in advance before image superimposing processing.

Meanwhile, when reading from the decoration image area DAREA the compressed decoration image data stored in the decoration image area DAREA in the above-described process P12, the image superimposing circuit IMGSPC5 reads partial decoration image data DIMGa at coordinates where superimposing information corresponds to “1” from the decoration image area DAREA. For example, in processing of a first line of the decoration image DIMG, superimposing information in the pixel map PMAP corresponding to the first line of the decoration image DIMG is “11111”, so that the image superimposing circuit IMGSPCS reads all partial decoration image data DIMGa (“12345”) from the decoration image area DAREA (process P122 (1)).

Second and thereafter lines of the decoration image DIMG are processed according to the pixel map PMAP, similarly to the above-described process P122(1). Symbols “x” shown on right sides of processes P122(2) to P122(4) denote pixel data of the partial decoration image DIMGa which the image superimposing circuit IMGSPC5 does not read from the decoration image area DAREA. The image superimposing circuit IMGSPC5 restores partial decoration image data DIMGa (“6xxx7”, “8xxx9”, “10xxx11” and “12-16”) of second, third, fourth and fifth lines of the decoration image DIMG. The image superimposing circuit IMGSPC5 accesses the line memory LM only for image data of 16 pixels in the decoration image DIMG constituted of 25 pixels.

As above, also in the sixth embodiment, the same effect as the above-described fifth embodiment can be obtained. Further, in this embodiment, only pixel data to be superimposed with the source image SIMG of the decoration image DIMG are stored in the line memory LM. Accordingly, the storage capacity of the decoration image area DAREA of the line memory LM can be reduced. Furthermore, since only pixel data of the decoration image DIMG to be superimposed with the source image SIMG are read from the line memory LM, the number of accesses to the line memory LM for reading the decoration image data DIMG can be reduced. Accordingly, the processing time needed for superimposing an image can be shorted by the reduced access time.

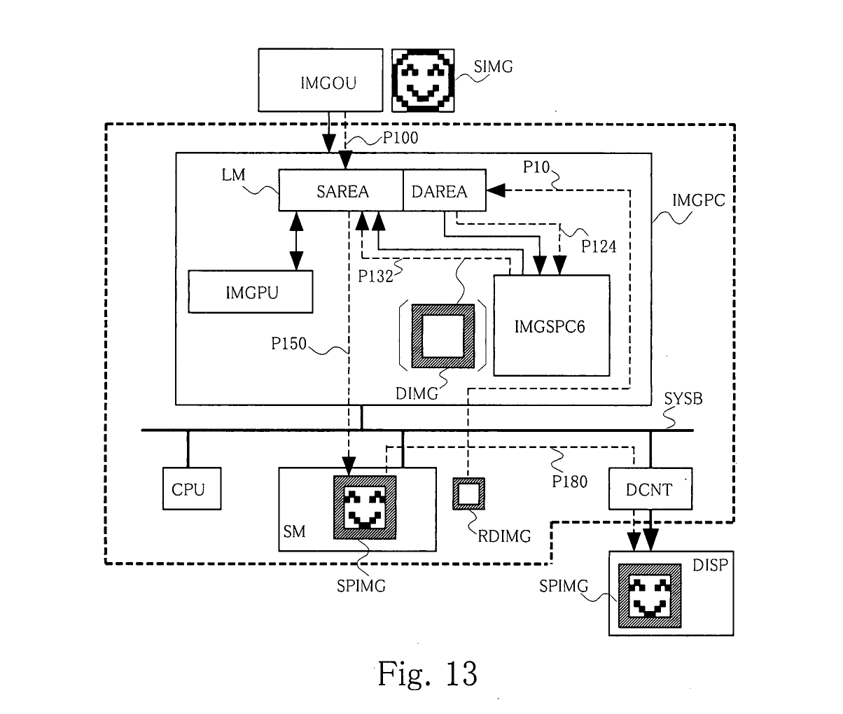

FIG. 13 shows a seventh embodiment of the present invention. The same elements as those explained in the third embodiment are designated the same reference symbols, and detailed descriptions of which are omitted. In an image processor of this embodiment, an image superimposing circuit IMGSPC6 is formed instead of the image superimposing circuit IMGSPC2 of the third embodiment. The other structure is the same as in the third embodiment. The image processor is mounted in a digital camera for example. In the image processor of this embodiment, instead of the processes P120 and P130 of the third embodiment, processes P124 and P132 are performed respectively. Processes P10, P100, P150 and P180 are the same as in the above-described third embodiment, and thus detailed descriptions of which are omitted.

The image superimposing circuit IMGSPC6 generates an original decoration image DIMG from a reduced decoration image RDIMG, which is made by reducing a decoration image DIMG. Accordingly, the decoration image area DAREA only needs to retain reduced decoration image data RDIMG that are smaller in data amount than the decoration image data DIMG, so that the decoration image area DAREA of the line memory LM can be reduced.

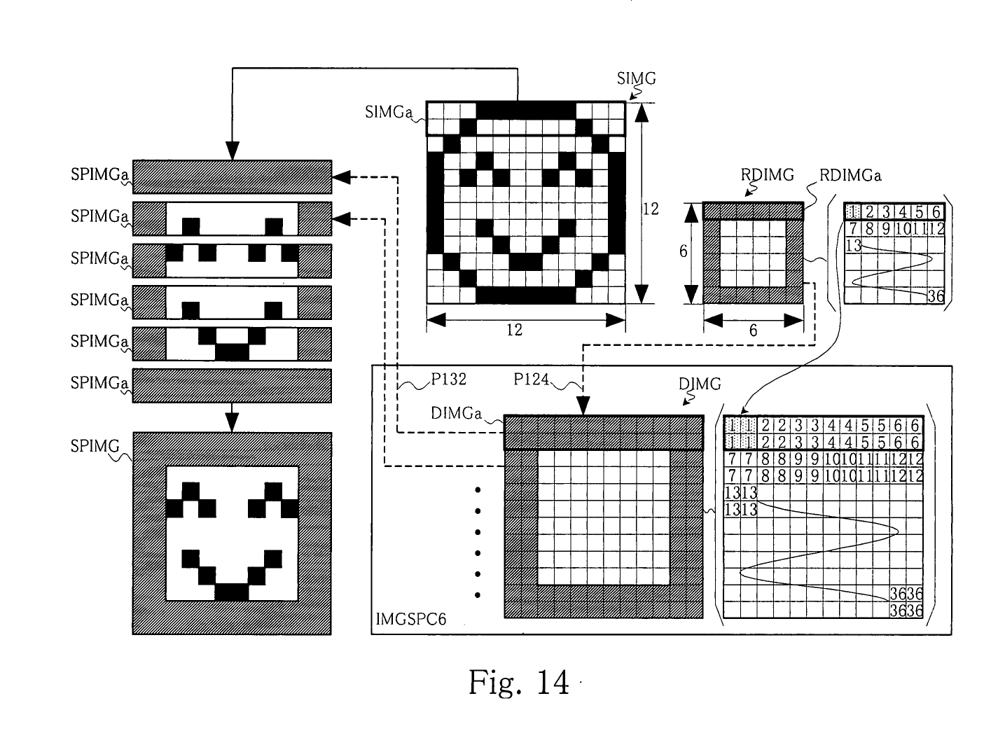

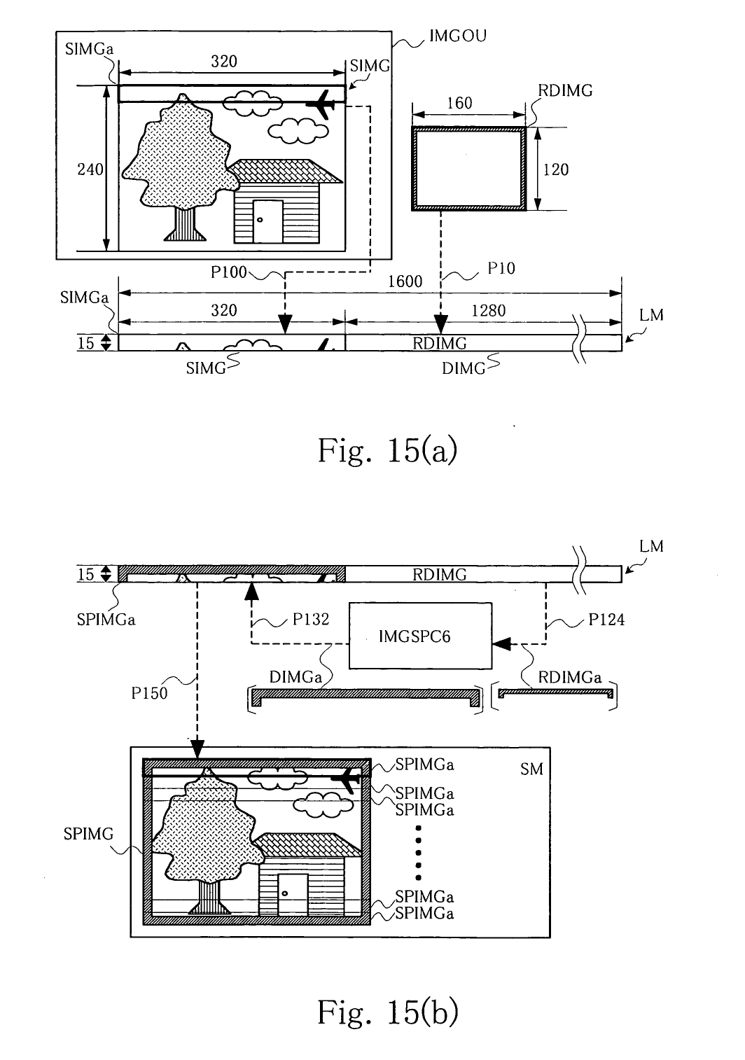

FIG. 14 shows an example of operation of the seventh embodiment. For simplification of explanation, sizes of a source image SIMG and a decoration image DIMG are set to 12 pixels×12 lines. In practice, the sizes of a source image SIMG and a decoration image DIMG are 320 pixels×240 lines or the like as shown in FIG. 15 described later. An oblique line portion (for example, a picture frame having a two-pixel width) on the periphery of the decoration image DIMG is superimposed with the source image SIMG. A void portion on the center of the decoration image DIMG (for example, with a size of 8 pixels×8 lines) is not superimposed with the source image SIMG. The reduced decoration image RDIMG is an image made by reducing the number of pixels of the decoration image DIMG to one quarter thereof. Specifically, the size of the reduced decoration image RDIMG is 6 pixels×6 pixels. Therefore, the decoration image area DAREA of the line memory LM just needs to be capable of image data of 36 pixels.

The image superimposing circuit IMGSPC6 overwrites respective pixel data of the reduced decoration image RDIMG as four pixel data of partial decoration image data DIMGa on partial source image data SIMGa retained in the source image area SAREA (processes P124, P132). In this manner, partial superimposing image data SPIMGa are generated. For example, image data “1” of the left top pixel of the reduced decoration image data RDIMG is image data of four pixels (“1”, “1”, “1”, “1”) at the top left corner of the decoration image data DIMG by enlargement. The criteria to overwrite the partial decoration image data DIMGa on the partial source image data SIMGa in the process P132 are the same as in the process P130 of the above-described FIG. 5. By processes P124 and P132, the image superimposing circuit IMGSPC6 generates partial decoration image data DIMGa from partial reduced decoration image data RDIMGa to superimpose the generated partial decoration image data DIMGa with the partial source image data SIMGa.

FIG. 15A and FIG. 15B show a concrete example of operation of the seventh embodiment. FIG. 15A shows operation until partial source image data SIMGa are stored in the line memory LM. FIG. 15B shows operation of superimposing partial source image data SIMGa retained in the line memory LM with partial decoration image data DIMGa. Sizes of a source image SIMG and a decoration image are the same as in the above-described third embodiment (FIG. 5). The storage capacity of the line memory LM is one quarter of the third embodiment (FIG. 5). Specifically, the line memory LM has a storage capacity of 1600 pixels×15 lines. Therefore, the source image area SAREA of the line memory LM is assigned a storage capacity to retain partial source image data SIMGa corresponding to 15 lines (320 pixels×15 lines) of the source image SIMG. The remaining area (1280 pixels×15 lines) of the line memory LM is used for the decoration image area DAREA. Accordingly, the decoration image area DAREA can retain reduced decoration image data RDIMG of 19200 pixels (160 pixels×240 lines).

Processes P10, P100, P150 and P180 are the same as in the above-described third embodiment. Processes P124 and P132 are the same as in the above-described FIG. 14. Detailed descriptions of these are omitted.

The image processing circuit IMGPC shown in FIG. 13 repeats the above-described processes P100-P150 for 16 times to output sequentially 16 partial superimposing image data SPIMGa from the line memory LM to the system memory SM. Thus, a screenful of superimposing image data SPIMG are stored in the system memory SM. In the image processor of this embodiment, the decoration image area DAREA only needs to retain the reduced decoration image data RDIMG with a data amount of one quarter of the decoration image data DIMG, so that the storage capacity of the decoration image area DAREA of the line memory LM can be reduced. The storage capacity of the line memory LM needs to be only one quarter as compared with the line memory LM of the image processor of the fifth embodiment of the above-described FIG. 5.

As above, in the seventh embodiment, the same effect as the above-described third embodiment can be obtained. Furthermore, since the decoration image area DAREA of the line memory LM only needs to retain image data of the reduced decoration image RDIMG made by reducing the decoration image DIMG, the storage capacity of the line memory LM can be reduced. Further, also in processing of storing the reduced decoration image data RDIMG in the line memory LM prior to image superimposing processing, the reduced decoration image data RDIMG that is smaller in data amount than the decoration image data DIMG are transferred via the system bus SYSB, so that increase in system bus utilization SYSB can be prevented.

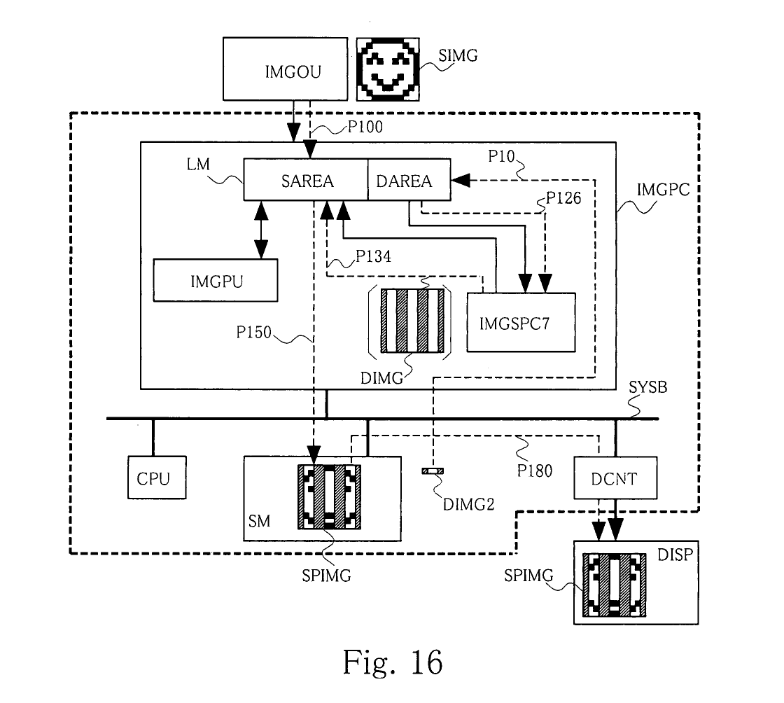

FIG. 16 shows an eighth embodiment of the present invention. The same elements as those explained in the third embodiment are designated the same reference symbols, and detailed descriptions of which are omitted. In an image processor of this embodiment, an image superimposing circuit IMGSPC7 is formed instead of the image superimposing circuit IMGSPC2 of the third embodiment. The other structure is the same as in the third embodiment. The image processor is mounted in a digital camera for example. In the image processor of this embodiment, instead of the processes P120 and P130 of the third embodiment, processes P126 and P134 are performed respectively. Processes P10, P100, P150 and P180 are the same as in the above-described third embodiment, and thus detailed descriptions of which are omitted.

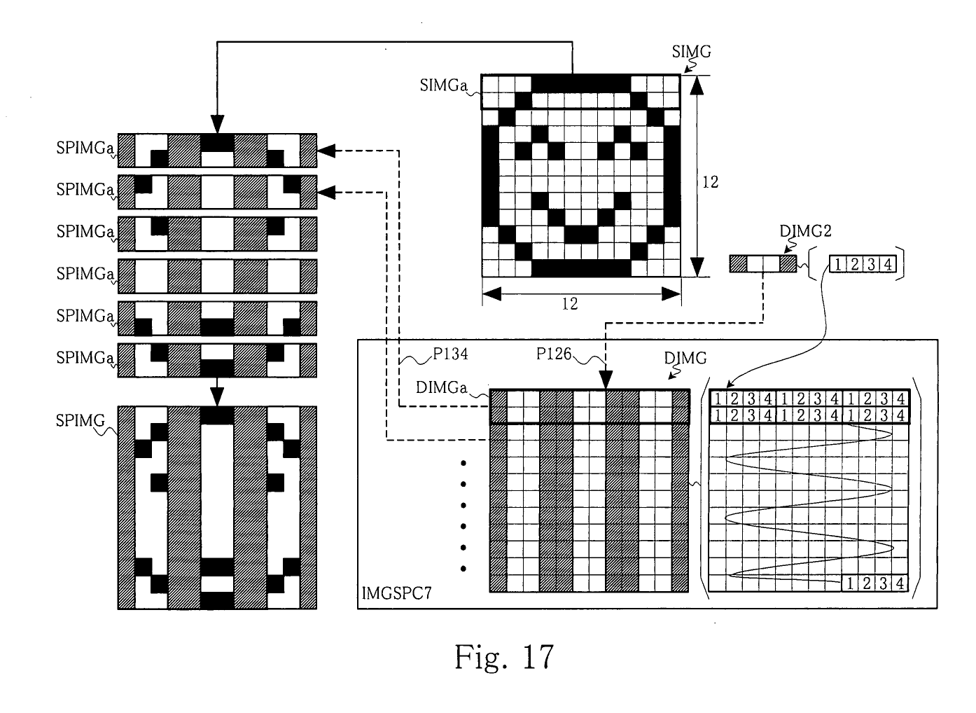

The image superimposing circuit IMGSPC7 arranges a second decoration image DIMG2 repeatedly, which is a decorated image smaller than a source image SIMG, to generate a decoration image DIMG corresponding to the source image SIMG. The decoration image area DAREA only needs to retain the second decoration image data DIMG2 that are smaller in data amount than the decoration image data DIMG, so that the storage capacity of the decoration image area DAREA of the line memory LM can be reduced. Details of the image superimposing circuit IMGSPC7 will be explained with FIG. 17 described below.

FIG. 17 shows an example of operation of the eighth embodiment. The size of the source image SIMG and the size of the decoration image DIMG are the same as in the above-described seventh embodiment (FIG. 14). The size of the second decoration image DIMG2 is 4 pixels×1 line for example. An oblique line portion (two pixels on both sides) of the second decoration image DIMG2 is superimposed with the source image SIMG. A void portion (two pixels on the center) of the second decoration image DIMG2 is not superimposed with the source image SIMG.

The image superimposing circuit IMGSPC7 uses the second decoration image data DIMG2 (“1234”) repeatedly three times in a horizontal direction and twice in a vertical direction to generate partial decoration image data DIMGa (six “1234”) (process P126). The image superimposing circuit IMGSPC7 overwrites the generated partial decoration image data DIMGa (six “1234”) on the partial source image data SIMGa retained in the source image area SAREA to generate partial superimposing image data SPIMGa (process P134). The criteria to overwrite the partial decoration image data DIMGa on the partial source image data SIMGa in the process P134 are the same as in the process P130 of the above-described FIG. 5. The image superimposing circuit IMGSPC7 repeats the above-described processes P126 and P134 six times to generate six partial superimposing image data SPIMGa sequentially to generate superimposing image data SPIMG.

As above, also in the eighth embodiment, the same effect as the above-described third embodiment can be obtained. Furthermore, the decoration image area DAREA of the line memory LM only needs to retain image data of a second decoration image DIMG2 (for example, image data of four pixels) smaller than a source image SIMG, so that the storage capacity of the line memory LM can be reduced. Further, also in processing of storing the second decoration image data DIMG2 in the line memory LM prior to image superimposing processing, the second decoration image data DIMG2 that is smaller in data amount than the decoration image data DIMG are transferred via the system bus SYSB, so that increase in system bus utilization SYSB can be prevented.

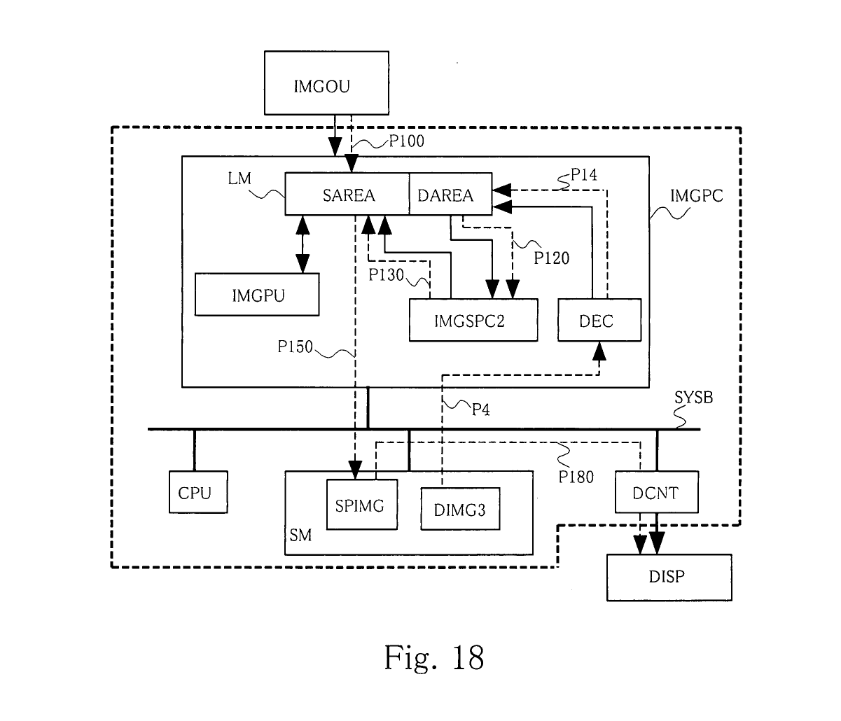

FIG. 18 shows a ninth embodiment of the present invention. The same elements as those explained in the third embodiment are designated the same reference symbols, and detailed descriptions of which are omitted. An image processor of this embodiment is constituted by adding a decoder DEC to the third embodiment. The other structure is the same as in the third embodiment. The image processor is mounted in a digital camera for example. In the image processor of this embodiment, instead of the process P10 in the third embodiment, processes P4 and P14 are performed. Processes P100-P180 are the same as in the above-described third embodiment, and thus detailed descriptions of which are omitted.

The decoder DEC is connected to the line memory LM. The decoder DEC is a device to decode encoded data, which are made by encoding data, into original data, such as a JPEG decoder for example. Encoded decoration data DIMG3 are data made by encoding decoration image data DIMG in JPEG format for example. The encoded decoration data DIMG3 are stored in the system memory SM for example.

First, in process P4, the decoder DEC reads the encoded decoration data DIMG3 stored in the system memory SM before image superimposing processing. The decoder DEC decodes the read encoded decoration data DIMG3 into decoration image data DIMG. In process P14, the decoder DEC writes the decoded decoration image data DIMG on the decoration image area DAREA of the line memory LM. The above-described processing is executed in advance before image superimposing processing. Processes P100-P180 are the same as in the above-described third embodiment.

As above, also in the ninth embodiment, the same effect as the above-described third embodiment can be obtained. Furthermore, since the image processor of this embodiment has the decoder DEC, encoded decoration data DIMG3 (for example, data encoded in JPEG format) made by encoding original decoration image data DIMG can be used. Accordingly, also in processing of storing the decoration image data DIMG in the line memory LM prior to image superimposing processing, the encoded decoration data DIMG3 that is smaller in data amount than the decoration image data DIMG are transferred via the system bus SYSB, so that increase in system bus utilization SYSB can be prevented.

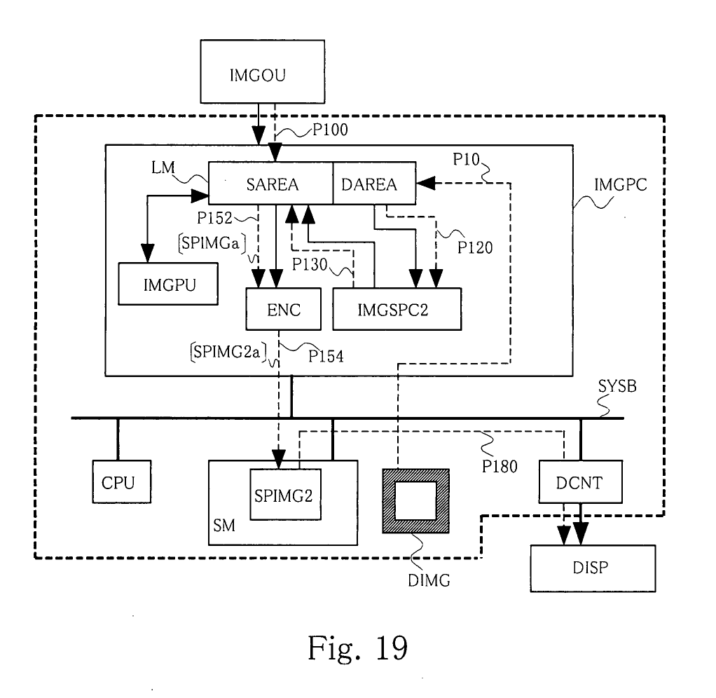

FIG. 19 shows a tenth embodiment of the present invention. The same elements as those explained in the third embodiment are designated the same reference symbols, and detailed descriptions of which are omitted. An image processor of this embodiment is constituted by adding an encoder ENC to the third embodiment. The other structure is the same as in the third embodiment. The image processor is mounted in a digital camera for example. In the image processor of this embodiment, instead of the process P150 of the third embodiment, processes P152 and P154 are performed. Processes P100-P130 and 180 are the same as in the above-described third embodiment, and thus detailed descriptions of which are omitted. The encoder ENC is connected to the line memory LM. The encoder ENC is a device which encodes image data, such as a JPEG encoder for example.

The processes P100-P130 which are the same as in the above-described third embodiment are performed, and partial superimposing image data SPIMGa are stored in the line memory LM. In the process P152, the encoder ENC sequentially reads the partial superimposing image data SPIMGa from the line memory LM. The encoder ENC encodes the read partial superimposing image data SPIMGa in JPEG format for example, and sequentially generates partial encoded superimposing data SPIMG2a. In the process P154, the image processing circuit IMGPC sequentially writes the generated partial encoded superimposing data SPIMG2a in the system memory SM. In the image processor in this embodiment, the above processing is repeated until a screenful of superimposing image data SPIMG are encoded. Thus, in the system memory SM, encoded superimposing data SPIMG2 made by encoding the screenful of superimposing image data SPIMG are stored.

As above, also in the tenth embodiment, the same effect as the above-described third embodiment can be obtained. Furthermore, since the image processor of this embodiment has the encoder ENC, encoded superimposing data SPIMG2 (for example, data encoded in JPEG format) made by encoding the superimposing image data SPIMG can be generated. Accordingly, for encoding the superimposing image data SPIMG, it is not necessary to use the system bus SYSB. As a result, in the case of encoding the superimposing image data SPIMG, increase in system bus utilization SYSB can be prevented. Furthermore, since the encoded superimposing data SPIMG2 that are smaller in data amount than the superimposing image data SPIMG are outputted to the system memory SM, increase in system bus utilization SYSB can be prevented.

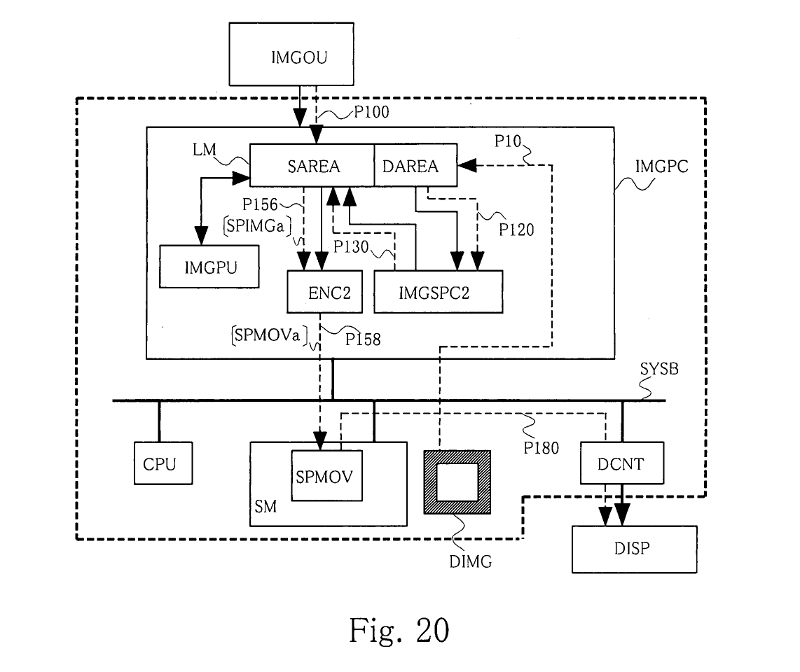

FIG. 20 shows an eleventh embodiment of the present invention. The same elements as those explained in the tenth embodiment are designated the same reference symbols, and detailed descriptions of which are omitted. In an image processor of this embodiment, a moving image encoder ENC2 is formed instead of the encoder ENC of the tenth embodiment. The other structure is the same as in the tenth embodiment. The image processor is mounted in a digital camera for example. In the image processor of this embodiment, instead of the processes P152 and P154 of the tenth embodiment, processes P156 and P158 are performed respectively. Processes P100-P130 and 180 are the same as in the above-described tenth embodiment, and thus detailed descriptions of which are omitted. The moving image encoder ENC2 is connected to the line memory LM. The moving image encoder ENC2 is a device which encodes image data as a moving image, for example MPEG1, 2, 4 encoders or the like.

In the process P156, the moving image encoder ENC2 sequentially reads partial superimposing image data SPIMGa from the line memory LM. The moving image encoder ENC2 encodes the read partial superimposing image data SPIMGa in an encoding format of moving image such as MPEG1 format for example to thereby sequentially generate partial encoded superimposing moving image data SPMOVa. In the process P158, the image processing circuit IMGPC sequentially writes the generated partial encoded superimposing moving image data SPMOVa in the system memory SM. In the image processor of this embodiment, the above-described processing is repeated until a screenful of superimposing image data SPIMG are encoded. Accordingly, the system memory SM stores therein encoded superimposing moving image data SPMOV made by encoding the screenful of superimposing image data SPIMG as a moving image.

As above, also in the eleventh embodiment, the same effect as the above-described third embodiment can be obtained. Furthermore, since the image processor of this embodiment has the moving image encoder ENC2, encoded superimposing moving image data SPMOV (for example, data encoded in any one of MPEG 1, 2, 4 formats) made by encoding the superimposing image data SPIMG as a moving image can be generated. Accordingly, for encoding the superimposing image data SPIMG as a moving image, it is not necessary to use the system bus SYSB. As a result, in the case of encoding the superimposing image data SPIMG as a moving image, increase in system bus utilization SYSB can be prevented.

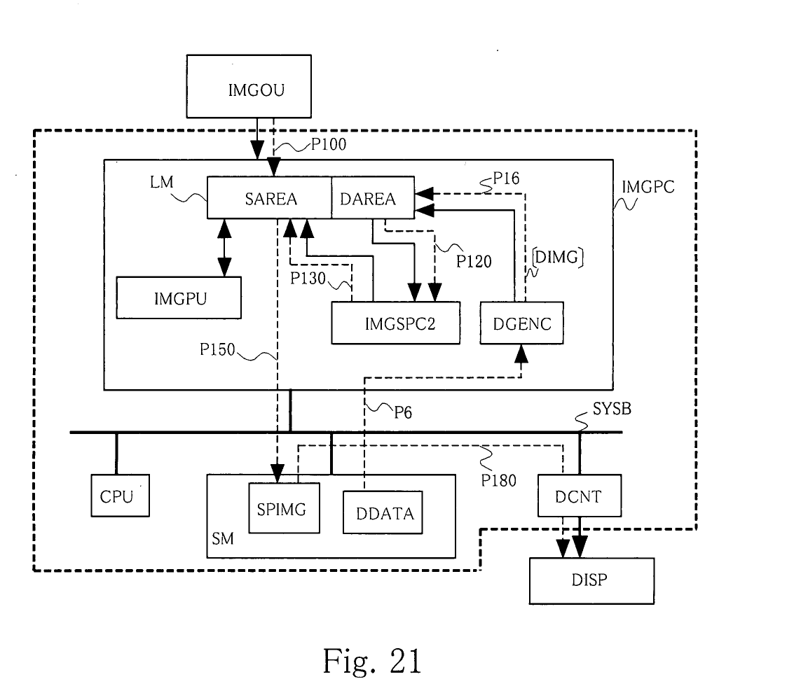

FIG. 21 shows a twelfth embodiment of the present invention. The same elements as those explained in the third embodiment are designated the same reference symbols, and detailed descriptions of which are omitted. An image processor of this embodiment is constituted by adding a decoration image generation controller DGENC to the third embodiment. The other structure is the same as in the third embodiment. The image processor is mounted in a digital camera for example. In the image processor of this embodiment, instead of the process P10 of the third embodiment, processes P6 and P16 are performed. Processes P100-P180 are the same as in the above-described third embodiment, and thus detailed descriptions of which are omitted. The decoration image generation controller DGENC is connected to the line memory LM.

The decoration image generation controller DGENC is a device which generates decoration image data DIMG from basic decoration data DDATA by operation or the like. For example, the decoration image generation controller DGENC generates decoration image data DIMG of a geometric pattern or the like by operating the basic decoration data DDATA. The basic decoration data DDATA are, for example, a radius and coordinates of the center of a circle or the like, which may be smaller in data amount than the decoration image data DIMG. The basic decoration data DDATA are stored, for example, in the system memory SM.

First, in the process P6 before the image superimposing processing, the decoration image generation controller DGENC reads basic decoration data DDATA stored in the system memory SM. The decoration image generation controller DGENC operates the read basic decoration data DDATA to generate decoration image data DIMG. In the process P16, the decoration image generation controller DGENC writes the generated decoration image data DIMG in the decoration image area DAREA of the line memory LM. The above processing is executed in advance before image superimposing processing. The processes P100-P180 are the same as in the above-described third embodiment.

As above, also in the twelfth embodiment, the same effect as the above-described third embodiment can be obtained. Furthermore, since the image processor of this embodiment has the decoration image generation controller DGENC, decoration image data DIMG can be generated from basic decoration data DDATA of geometric data or the like. Accordingly, in this embodiment, the basic decoration data DDATA of geometric data or the like can be used as basic data for the decoration image data DIMG. Thus, when the basic decoration data DDATA is smaller in the data amount than the decoration image data DIMG, the amount of data to be transferred via the system bus SYSB is small also during a processing prior to image superimposing processing in which the decoration image data DIMG is stored in the line memory LM, which makes it possible to prevent increase in system bus utilization SYSB.

It should be noted that the above-described embodiments have described examples in which the image processor is mounted in a digital camera. However, the present invention is not limited to such embodiments. For example, the image processor according to the present invention can be mounted in an electronic apparatus having a camera function such as a mobile phone with a camera, digital video camera, or the like. Also in this case, the same effect as the above-described embodiments can be obtained.

The above-described embodiments have described examples in which when the partial source image data SIMGa and the partial decoration image data DIMGa are superimposed, pixel data of either the partial source image data SIMGa or the partial decoration image data DIMGa are used as pixel data of the partial superimposing image data SPIMGa. The present invention is not limited to such embodiments. For example, the image superimposing circuit IMGSPC may average pixel data of both the partial source image data SIMGa and the partial decoration image data DIMGa to use averaged pixel data as the partial superimposing image data SPIMGa. Also in this case, the same effect as in the above-described embodiments can be obtained.

The above-described first embodiment has described an example in which the source image area SAREA of the line memory LM is assigned a storage capacity of retaining image data of 60 lines of the source image SIMG. The present invention is not limited to such an embodiment. For example, the source image area SAREA of the line memory LM may be assigned a storage capacity of retaining image data of one line of the source image SIMG. Specifically, the source image area SAREA of the line memory LM may be assigned a storage capacity of retaining image data of at least one line of the source image SIMG. Similarly, in the second to twelfth embodiments, the source image area SAREA of the line memory LM may be assigned a storage capacity of retaining image data of one line of the source image SIMG. Also in this case, the same effect as the above-described first to twelfth embodiments can be obtained respectively.

The above-described first embodiment has described an example in which the partial source image data SIMGa and the partial decoration image data DIMGa are superimposed to output superimposed partial superimposing image data SPIMGa to the system bus SYSB without being written back to the line memory LM. The present invention is not limited to such an embodiment. For example, the image superimposing circuit IMGSPC may overwrite as shown in FIG. 5 the partial decoration image data DIMGa on the partial source image data SIMGa retained in the source image area SAREA of the line memory LM to superimpose the partial source image data SIMGa with the partial decoration image data DIMGa. Also in this case, similarly to the above-described first embodiment, increase in system bus utilization SYSB can be prevented.

The above-described sixth embodiment has described an example in which the partial decoration image data DIMGa is overwritten on the partial source image data SIMGa to generate the partial superimposing image data SPIMGa. The present invention is not limited to such an embodiment. For example, the image superimposing circuit IMGSPC5 may read, as shown in FIG. 2, the partial source image data SIMGa and the partial decoration image data DIMGa from the line memory LM, superimpose the partial source image data SIMGa with the partial decoration image data DIMGa, and output sequentially the superimposed partial superimposing image data SPIMGa to the system memory SM without writing back to the line memory LM. Similarly, in the sixth to twelfth embodiments, the image superimposing circuits IMGSPC2, IMGSPC6, and IMGSPC7 may read the partial source image data SIMGa and the partial decoration image data DIMGa from the line memory LM, superimpose the partial source image data SIMGa with the partial decoration image data DIMGa, and output sequentially the superimposed partial superimposing image data SPIMGa to the system memory SM without writing back to the line memory LM. Also in this case, the same effect as the above-described sixth to twelfth embodiments can be obtained respectively.

The above-described sixth embodiment has described an example in which the decoration image compression unit DCOMP is used to write decoration image data made by compressing decoration image data DIMG in the line memory LM. The present invention is not limited to such an embodiment. For example, the decoration image compression unit DCOMP or the like may be used to create decoration image data made by compressing the decoration image data DIMG in advance and prepare them in a system such as a digital camera. In this case, the image processor does not need to have the decoration image compression unit DCOMP. Also in this case, the same effect as the above-described sixth embodiment can be obtained.

The above-described seventh embodiment has described an example in which the partial source image data SIMGa and the partial decoration image data DIMGa are superimposed without using the pixel map PMAP. The present invention is not limited to such an embodiment. For example, the image superimposing circuit IMGSPC6 may superimpose, as shown in FIG. 10, the partial source image data SIMGa with the partial decoration image data DIMGa based on the pixel map PMAP. Similarly, in the eighth to twelfth embodiments, the image superimposing circuit IMGSPC2 and IMGSPC7 may superimpose the partial source image data SIMGa with the partial decoration image data DIMGa based on the pixel map PMAP. Also in this case, the same effect as those described in the seventh to twelfth embodiments can be obtained respectively.

The above-described seventh embodiment has described an example in which, in order to superimpose the partial source image data SIMGa with the partial decoration image data DIMGa, the partial decoration image data DIMGa corresponding to the partial source image data SIMGa are generated by enlargement processing from the reduced decoration image data RDIMG retained in the line memory LM. The present invention is not limited to such an embodiment. For example, the partial decoration image data DIMGa corresponding to the partial source image data SIMGa may be generated by reduction processing from image data retained in the decoration image area of the line memory LM. Accordingly, when the size of a source image SIMG becomes smaller than a decoration image DIMG generated from decoration image data DIMG retained the line memory LM, it is not necessary to change the decoration image data DIMG retained in the line memory LM. Also in this case, the same effect as the above-described third embodiment can be obtained.

The above-described ninth and tenth embodiments have described an example in which the encoded decoration data DIMG3 made by encoding the decoration image data DIMG are decoded and an example in which the encoded superimposing data SPIMG2 made by encoding the superimposing image data SPIMG are generated. The present invention is not limited to such embodiments. For example, the ninth and tenth embodiments may be combined. In this case, the image processor can use encoded data made by encoding image data as image data for input and output. Also in this case, the same effect as the above-described ninth and tenth embodiments can be obtained.

The invention is not limited to the above embodiments and various modifications may be made without departing from the spirit and scope of the invention. Any improvement may be made in part or all of the components.

What is claimed is:

1. An image processor, comprising:
a line memory having a source image area and a decoration image area allocated thereto, the source image area sequentially retaining therein partial source image data which corresponds to at least one line of a screenful of a source image, the decoration image area retaining therein decoration image data which corresponds to a decoration image for decoration of the source image; and
an image superimposing circuit which repeatedly performs superimposing processing to superimpose the partial source image data retained in said line memory with partial decoration image data, until the source image is superimposed, the partial decoration image data corresponding to partial source image data.

2. The image processor according to claim 1, wherein
said image superimposing circuit reads the partial source image data and the partial decoration image data from said line memory, superimposes the read partial image data with each other, and sequentially outputs superimposed image data.

3. The image processor according to claim 1, wherein
said image superimposing circuit reads the partial decoration image data from said line memory, and overwrites the partial source image data retained in said source image area with the read partial decoration image data, to thereby superimpose the partial decoration image data with the partial source image data.

4. The image processor according to claim 1, wherein
said image superimposing circuit superimposes a pixel of the partial decoration image data with the partial source image data, the pixel having a color different from a predetermined pixel color.

5. The image processor according to claim 1, further comprising
a pixel map storing information indicating whether or not each pixel of the decoration image data is to be superimposed, wherein
said image superimposing circuit superimposes the partial source image data with the partial decoration image data based on the information stored in said pixel map.

6. The image processor according to claim 5, wherein:
said line memory retains, in said decoration image area, decoration image data which corresponds to a pixel to be superimposed indicated by the information in said pixel map; and
said image superimposing circuit superimposes the partial decoration image data retained in said decoration image area with the partial source image data when the information stored in said pixel map indicates that a pixel of the decoration image data is to be superimposed.

7. The image processor according to claim 1, wherein:
said line memory retains, in said decoration image area, reduced decoration image data which corresponds to a reduced decoration image; and
said image superimposing circuit partially reads the reduced decoration image data retained in said decoration image area, generates, from the read partial reduced decoration image data, partial decoration image data corresponding to a part of an original decoration image, and superimposes generated partial decoration image data with the partial source image data, the partial reduced decoration image data corresponding to the partial source image data.

8. The image processor according to claim 1, wherein:
the decoration image is generated by periodically arranging a second decoration image smaller in size than the source image;
said line memory retains, in said decoration image area, second decoration image data which corresponds to the second decoration image smaller in size than the source image; and
said image superimposing circuit reads the second decoration image data retained in said decoration image area, repeatedly uses the read second image data to generate the partial decoration image data, and superimposes generated partial decoration image data with the partial source image data.

9. The image processor according to claim 1, further comprising:
a system memory which retains encoded decoration data generated by encoding the decoration image data; and
an image decoder which decodes the encoded decoration data retained in said system memory to generate the decoration image data to be retained in said decoration image area.

10. The image processor according to claim 1, further comprising
an image encoder which encodes superimposing image data superimposed by said image superimposing circuit.

11. The image processor according to claim 10, wherein
said image encoder encodes, as moving image data, superimposing image data superimposed by said image superimposing circuit.

12. The image processor according to claim 1, further comprising:
a system memory which retains basic data for generation of a decoration image; and
a decoration image generation controller which generates the decoration image data to be retained in said decoration image area from the basic data retained in said system memory.

13. An image processing method, comprising the steps of:
retaining decoration image data in a decoration image area allocated to a line memory, the decoration image data corresponding to a decoration image for decoration of a screenful of a source image;
sequentially retaining partial source image data in a source image area allocated to said line memory, the partial source image data corresponding to at least one line of the source image; and
repeatedly performing superimposing processing to superimpose the partial source image data retained sequentially in said line memory with partial decoration image data, until said source image is superimposed, the partial decoration image data corresponding to the partial source image data.

14. The image processing method according to claim 13, further comprising the steps of:
reading the partial source image data and the partial decoration image data from said line memory;
superimposing the read partial image data with each other; and
sequentially outputting superimposed image data.

15. The image processing method according to claim 13, further comprising the steps of:
reading the partial decoration image data from said line memory; and
overwriting the partial source image data retained in said source image area with the read partial decoration image data, to thereby superimpose the partial decoration image data with the partial source image data.

16. The image processing method according to claim 13, further comprising the step of
superimposing a pixel of the partial decoration image data with the partial source image data, the pixel having a color different from a predetermined pixel color.

17. The image processing method according to claim 13, further comprising the steps of:
retaining, as pixel map information, information indicating whether or not each pixel of the decoration image data is to be superimposed; and
superimposing the partial source image data with the partial decoration image data based on the pixel map information.

18. The image processing method according to claim 17, further comprising the steps of:
retaining, in the decoration image area of said line memory, decoration image data corresponding to a pixel to be superimposed indicated by the pixel map information; and
superimposing the partial decoration image data retained in said decoration image area with the partial source image data according to a pixel to be superimposed indicated by the pixel map information.

19. The image processing method according to claim 13, further comprising the steps of:
retaining, in the decoration image area of said line memory, reduced decoration image data corresponding to a reduced decoration image; and
partially reading the reduced decoration image data retained in said decoration image area, generating, from the read partial reduced decoration image data, partial decoration image data corresponding to a part of an original decoration image, and superimposing generated partial decoration image data with the partial source image data, the partial reduced decoration image data corresponding to the partial source image data.

20. The image processing method according to claim 13, further comprising the steps of:
retaining, in a system memory, encoded decoration data generated by encoding the decoration image data; and
decoding the encoded decoration data generated by encoding the decoration image data to generate the decoration image data to be retained in said decoration image area.
